(19) United States
(12) Patent Application Publication
(10) Pub. No.: US 2019/0376444 A1
(43) Pub. Date: Dec. 12, 2019

(54) INTERNAL COMBUSTION ENGINE FOR SADDLE-RIDING VEHICLE

(71) Applicant: HONDA MOTOR CO., LTD., TOKYO (JP)

(72) Inventors: Takahiro IWAMA, WAKO-SHI (JP); Katsunori KOMURO, WAKO-SHI (JP); Hiroya UEDA, WAKO-SHI (JP); Koji TERADA, WAKO-SHI (JP)

(21) Appl. No.: 16/432,062

(22) Filed: Jun. 5, 2019

(30) Foreign Application Priority Data
Jun. 6, 2018 (JP) 2018-108379

(51) Int. Cl. F02B 61/02; B62J 35/00; B62J 37/00; F04B 17/05

(52) U.S. Cl. CPC F02B 61/02; F04B 17/05; B62J 37/00; B62J 35/00

(57) ABSTRACT

An internal combustion engine is mounted on the saddle-riding vehicle. The engine includes: a cylinder head; a cylinder head cover; a fuel injection valve whose distal end is directed to a combustion chamber; a cam shaft; a fuel pump which feeds fuel due to an action of a cam which integrally rotates with the cam shaft; a fuel pump mounting member which is fixed to the cylinder head and on which the fuel pump is mounted; and a downstream side fuel pipe which feeds fuel from the fuel pump to the fuel injection valve and has flexibility. The above arrangement improves maintenance property by making a routing space of the fuel pipe compact by shortening the length of the fuel pipe while enhancing protection of the sides of the vehicle including the fuel pump.

### TECHNICAL FIELD

The present invention relates to an internal combustion engine for a saddle-riding vehicle where a fuel pump is disposed in a cylinder head portion.

### BACKGROUND ART

Patent Document 1 describes an internal combustion engine for a saddle-riding vehicle where a fuel pump is disposed on a side of a crankcase of the internal combustion engine. In such an internal combustion engine for a saddle-riding vehicle, a fuel pipe from a fuel pump to a fuel injection valve which is a fuel supply destination becomes long, and hence it is necessary to ensure a space for routing the fuel pipe. Further, it is necessary to protect the sides of the vehicle including the fuel pump and the fuel pipe extending from the fuel pump.

### PRIOR ART

### Patent Document

[Patent Document 1] JP 2017-180328 A

### SUMMARY OF INVENTION

### Underlying Problem to be solved by the Invention

It is an object of the present invention to provide an internal combustion engine for a saddle-riding vehicle where maintenance property can be enhanced by making a routing space of a fuel pipe compact by shortening the length of a fuel pipe through which fuel is supplied from a fuel pump to a fuel injection valve while enhancing protection of the sides of the vehicle including the fuel pump.

### Means to solve the Underlying Problem

The present invention has been made in view of the above-mentioned drawback, and is directed to an internal combustion engine for a saddle-riding vehicle, wherein the engine is mounted on the saddle-riding vehicle, the internal combustion engine comprising: a cylinder head having a combustion chamber formed therein; a cylinder head cover covering the cylinder head; a fuel injection valve having a distal end directed to the combustion chamber; a valve train cam shaft rotatably supported in the cylinder head and having thereon a cam integrally rotatable with the cam shaft; a fuel pump mounting member fixed to the cylinder head in a state where the fuel pump mounting member covers at least a portion of the cam shaft; a fuel pump for feeding fuel by an action of the cam, the fuel pump being fixedly mounted on the fuel pump mounting member; and a downstream side fuel pipe for supplying fuel from the fuel pump to the fuel injection valve, the downstream side fuel pipe having a flexibility.

In the present invention, the fuel pump is mounted on the fuel pump mounting member which is fixed to the cylinder head. Accordingly, the length of the downstream side fuel pipe which feeds fuel from the fuel pump to the fuel injection valve is shortened, and a routing space of the downstream side pipe is made compact, thus enhancing protection of sides of the vehicle including the fuel pump. With the use of the downstream side fuel pipe having flexibility, at the time of performing maintenance of the inside of the cylinder head, the maintenance of the inside of the cylinder head can be performed while maintaining a connected state of the downstream side fuel pipe, and hence maintenance property around the cylinder head can be enhanced.

In a preferred embodiment of the present invention, the cylinder head cover has an opening; the fuel pump mounting member has a mounting seat portion for mounting the fuel pump thereon; and the fuel pump mounting member is disposed such that the fuel pump mounting member penetrates the opening of the cylinder head cover in such a manner that the mounting seat portion protrudes from an upper surface of the cylinder head cover.

According to such an arrangement, the fuel pump mounting member is disposed such that it penetrates the opening of the cylinder head cover, and the mounting seat portion on which the fuel pump is mounted protrudes from the cylinder head cover. Accordingly, the fuel pump can be removed from the fuel pump mounting member while maintaining a joining state between the cylinder head cover and the cylinder head, and hence maintenance property of the fuel pump can be further enhanced in cooperation with flexibility of the fuel pipe.

In a preferred embodiment of the present invention, a seal member is interposed between the cylinder head cover and the fuel pump mounting member so as to extend along the opening.

According to such arrangement, the seal member is interposed between the cylinder head cover and the fuel pump mounting member so as to extend along the opening, and hence sealing is ensured between the opening of the cylinder head cover and the fuel pump mounting member without forming a gap, and it is thus possible to prevent leakage of oil at the time of removing and disassembling the fuel pump.

In a further preferred embodiment of the present invention, the downstream side fuel pipe has an upstream side connecting portion connected to the fuel pump and has a detouring portion routed in a vehicle lateral direction as viewed in plan view of the saddle-riding vehicle, with respect to a line which connects the upstream side connecting portion connected to the fuel pump and a downstream side connecting portion of the downstream side fuel pipe connected to the fuel injection valve.

According to such an arrangement, a moving amount of the fuel pipe mounted on the fuel pump is ensured due to the detouring portion of the fuel pipe, and hence maintenance property of the inside of the cylinder head cover can be enhanced.

In a preferred embodiment of the present invention, an upstream side fuel pipe is provided to feed fuel from a fuel tank to the fuel pump; the fuel pump has an intake side joint portion to which the upstream side fuel pipe is connected; and the intake side joint portion is disposed on a side of a head pipe of the saddle-riding vehicle.

According to such an arrangement, the intake side joint portion can be removed by making use of a wide space on the side of the head pipe, and hence operability of removing the upstream side fuel pipe at the intake side joint portion can be enhanced.

In a preferred embodiment of the present invention, the fuel pump is disposed between a pair of left and right main frame members extending from the head pipe.

According to such an arrangement, the fuel pump is not disposed on the side of the crankcase, but is disposed relatively close to the center of the vehicle, and hence protection of the vehicle from the sides thereof can be ensured.

In a further preferred embodiment of the present invention, the mounting seat portion of the fuel pump mounting member has a seat surface included in a fuel pump mounting plane; the fuel pump mounting member has a seal member mounting plane along which the seal member is mounted; and the fuel pump mounting plane on the fuel pump mounting member and the seal member mounting plane of the fuel pump mounting member have different angles.

According to such an arrangement, by making the fuel pump mounting plane, which includes the mounting seat surface of the seat portion, and the seal member mounting plane, on which the seal member is mounted, have different angles in the fuel pump mounting member, a direction of a mating surface between the cylinder head and the cylinder head cover and a direction of operating vibrations of the fuel pump can be made different from each other. Accordingly, the transmission of vibrations of the fuel pump can be decreased so that noise can be reduced.

### Advantageous Effects of Invention

According to the present invention, the length of the fuel pipe which feeds fuel from the fuel pump to the fuel injection valve can be shortened, and hence a routing space of the fuel pipe can be made compact so that the protection of the sides of the vehicle including the fuel pump can be enhanced. Further, at the time of performing maintenance of the inside of the cylinder head, the maintenance of the interior of the cylinder head can be performed by removing the fuel pump from the cylinder head while maintaining the connected state of the downstream side fuel pipe. Accordingly, maintenance property around the cylinder head can be enhanced.

### BRIEF DESCRIPTION OF DRAWINGS

FIG. 1 is a left side view of a motorcycle according to one embodiment of the present invention;

FIG. 2 is a left side view showing a main part in FIG. 1 on an enlarged scale;

FIG. 3 is a front view showing a main part in FIG. 2 on an enlarged scale;

FIG. 4 is a left side view showing a main part of an internal combustion engine and a fuel supply device;

FIG. 5 is a top plan view of a cylinder head;

FIG. 6 is a perspective view showing a state where a fuel pump mounting member, an intake cam shaft, and an exhaust cam shaft are mounted in the cylinder head;

FIG. 7 is a perspective view of a cylinder head cover;

FIG. 8 is a perspective view showing a state where the cylinder head cover is mounted on the cylinder head shown in FIG. 6;

FIG. 9 is a top plan view of the internal combustion engine;

FIG. 10 is a perspective view of the fuel pump mounting member and a seal member; and

FIG. 11 is an enlarged view of a main part in FIG. 4.

### MODE FOR CARRYING OUT THE INVENTION

A motorcycle 1, on which an internal combustion engine for a saddle-riding vehicle according to an embodiment of the present invention is mounted, will be described with reference to the drawings.

In the description of this specification, directions of front and rear, left and right, and up and down are directions of the motorcycle 1 on which the embodiment of the invention is mounted. In the drawings, an arrow FR indicates a frontward direction of the vehicle, an arrow RE indicates a rearward direction of the vehicle, an arrow LH indicates a leftward direction of the vehicle, an arrow RH indicates a rightward direction of the vehicle, and an arrow UP indicates an upward direction of the vehicle, respectively.

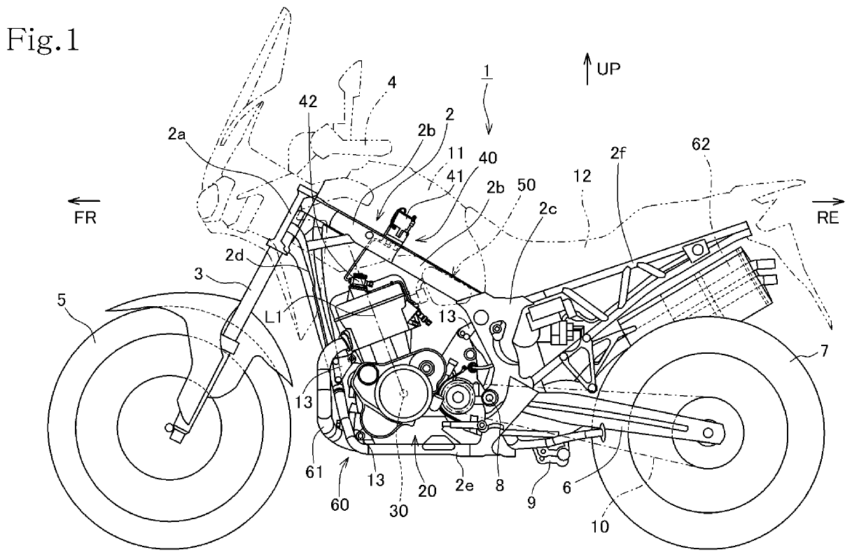

FIG. 1 is a left side view of the motorcycle 1, on which the internal combustion engine according to the embodiment of the present invention is mounted, in a state where a cover and the like are removed. A body frame 2 of the motorcycle 1 includes: a head pipe 2a; a pair of left and right main frame members 2b which extends obliquely rearward from the head pipe 2a; a pair of left and right center frame members 2c which extends downward from rear ends of the main frame members 2b; a single down frame member 2d which extends rearward and downward from the head pipe 2a at a steep angle; a pair of left and right lower frame members 2e, and a seat stay 2f which extends rearward and slightly upward from upper portions and lower portions of the center frame members 2c. The pair of left and right lower frame members 2e is connected to a lower end of the down frame member 2d, is bifurcated obliquely leftward and obliquely rightward, extends downward and, thereafter, is bent and extends rearward approximately horizontally, and is connected to lower ends of the pair of left and right center frame members 2c.

A front fork 3 which supports a front wheel 5 is steerably supported on the head pipe 2a, and a steering handle 4 is connected to the front fork 3. A rear fork 6 which supports a rear wheel 7 is supported in a vertically swingable manner using a pivot portion 8 formed on lower portions of the center frame members 2c as a fulcrum, and a cushion unit not shown in the figure is disposed between the upper portions of the center frame members 2c and the rear fork 6 by way of a link mechanism 9.

A fuel tank 11 for storing fuel is mounted on the left and right main frame members 2b, and a tandem-type seat 12 for the rider and a pillion passenger is mounted on the center frame members 2c and the seat stay 2f. The fuel tank 11 includes a low-pressure fuel pump 41 which feeds fuel in the fuel tank 11.

An internal combustion engine 20 is mounted on the lower frame members 2e and the center frame members 2c of the body frame 2 by way of brackets 13. The internal combustion engine 20 is positioned below the fuel tank 11, and is mounted on the motorcycle 1 in a posture that a crankshaft 30 is directed in a vehicle width direction, and a cylinder axis L1 of a cylinder is inclined slightly frontward.

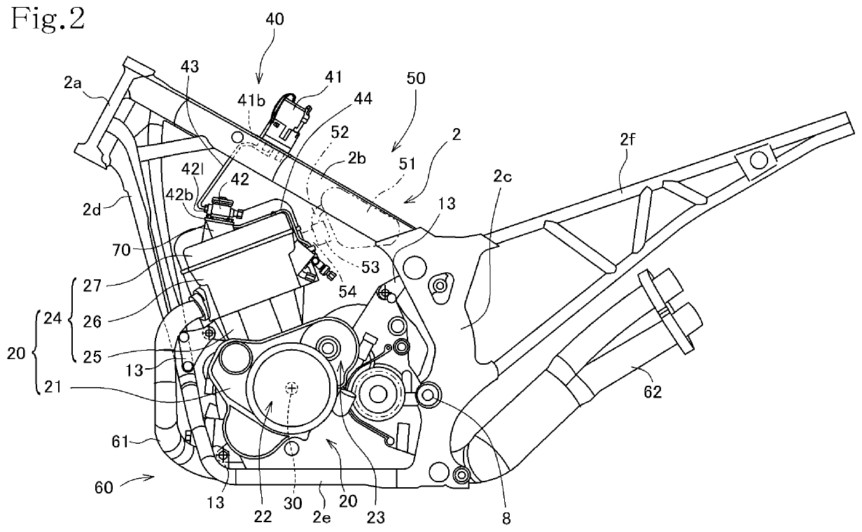

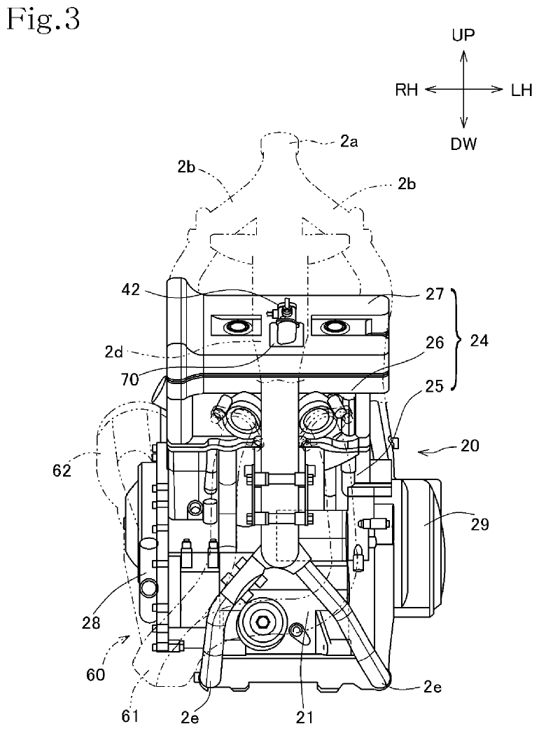

The internal combustion engine 20 is an air-cooled, two-cylinder, four-stroke cycle internal combustion engine, and is an upright internal combustion engine where the cylinder axis L1 takes an upright attitude raised from a horizontal plane. As shown in FIG. 2 and FIG. 3, the internal combustion engine 20 is configured such that a cylinder portion 24 is mounted on a crankcase 21, and the cylinder portion 24 is fastened and fixed to the crankcase 21 using stud bolts and the like not shown in the drawings. The cylinder portion 24 includes a cylinder block 25, a cylinder head 26, and a cylinder head cover 27 which covers an upper surface of the cylinder head 26. The cylinder block 25, the cylinder head 26, and the cylinder head cover 27 are made to sequentially overlap with the crankcase 21 from above.

As shown in FIG. 3, both left and right side surfaces of the crankcase 21 are covered by a right case cover 28 and a left case cover 29.

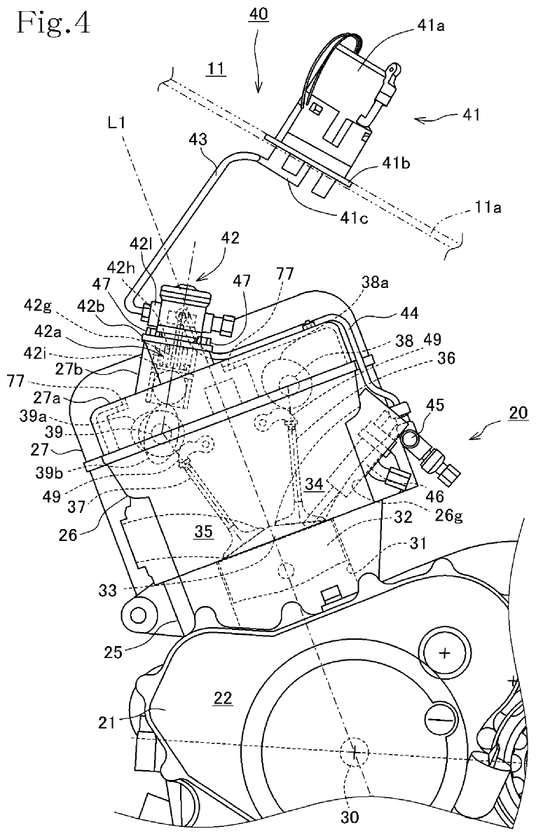

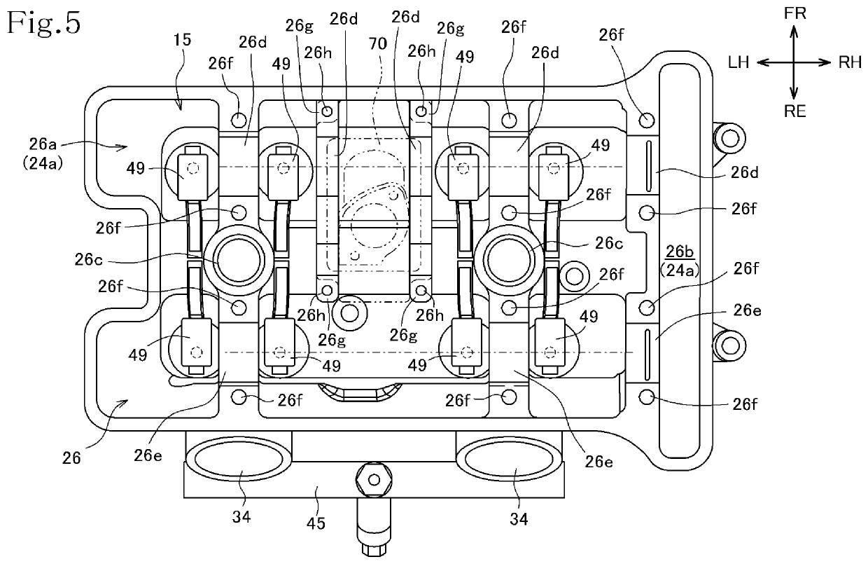

As shown in FIG. 4, cylinder bores 31 are formed in the cylinder block 25. That is, two cylinder bores 31 are arranged in the cylinder block 25 in a width direction of a vehicle body (see FIG. 5). Pistons 32 which are slidably fitted in the respective cylinder bores 31 are connected to the crankshaft 30 which is directed in the vehicle width direction by way of connecting rods (not shown in the drawings).

Combustion chambers 33 are formed on a lower surface of the cylinder head 26 so as to opposedly face the cylinder bores 31 respectively. Intake ports 34 and exhaust ports 35 which are communicated with the combustion chambers 33 respectively are formed in the cylinder head 26 such that the intake port 34 and the exhaust port 35 confront each other in a longitudinal direction of the motorcycle.

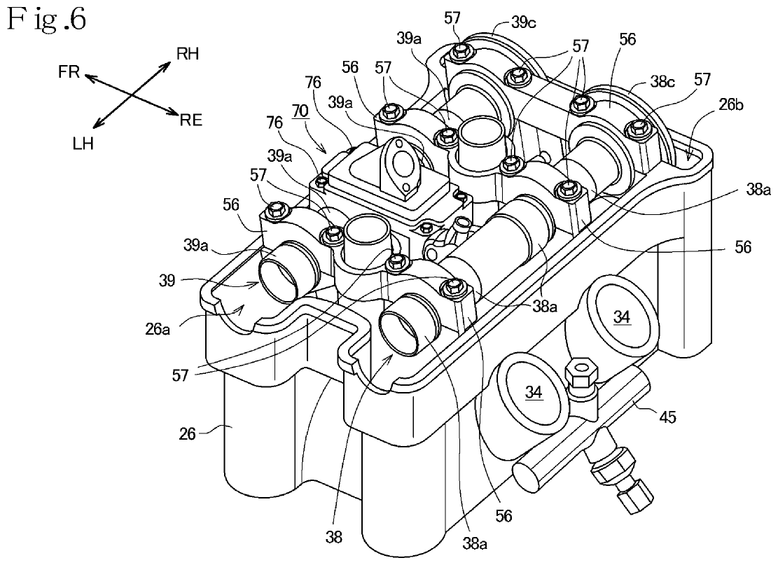

As shown in FIG. 5 and FIG. 6, a valve train housing portion 26a, in which a valve train 15 is housed, is formed in the cylinder head 26, and a cam chain chamber portion 26b, which is longer in the vehicle longitudinal direction than the valve train housing portion 26a, is formed adjacently to a right side of the valve train housing portion 26a.

As shown in FIG. 5, a pair of left and right fuel injection valve insertion sleeve portions 26c is formed on an upper surface of the cylinder head 26. Intake cam shaft bearing portions 26d are disposed on a front side of the upper surface of the cylinder head 26 contiguously with the fuel injection valve insertion sleeve portions 26c, while exhaust cam shaft bearing portions 26e are disposed on a rear side of the upper surface of the cylinder head 26 contiguously with the fuel injection valve insertion sleeve portions 26c. Bolt holes 26f, to which bolts 57 for mounting cam shaft holders 56 described later are fastened, are formed in the cylinder head 26 at positions in front of and behind the intake cam shaft bearing portion 26d and at positions in front of and behind the exhaust cam shaft bearing portion 26e.

A pair of fuel pump mounting member fixing portions 26g, on which a fuel pump mounting member 70 to be described later is mounted, is disposed on the upper surface of the cylinder head 26. The fuel pump mounting member fixing portions 26g are provided between the pair of fuel injection valve insertion sleeve portions 26c, and are positioned with a predetermined distance therebetween in a vehicle transverse direction. The intake cam shaft bearing portion 26d is also formed on each of the fuel pump mounting member fixing portions 26g. Bolt holes 26h, to which a bolt 76 for fixing the fuel pump mounting member 70 is fastened respectively, are formed in each fuel pump mounting member fixing portion 26g at a distance in a vehicle longitudinal direction.

As shown in FIG. 4, an intake cam shaft 38 and an exhaust cam shaft 39 are housed in the cylinder head 26 and the cylinder head cover 27. As shown in FIG. 6, a plurality of intake cams 38a are formed on the intake cam shaft 38, and a plurality of exhaust cams 39a are formed on the exhaust cam shaft 39. A cam gear 38c is mounted on a right end of the intake cam shaft 38 in an integrally rotatable manner, and a cam gear 39c is mounted on a right end of the exhaust cam shaft 39 in an integrally rotatable manner. As shown in FIG. 4, a high-pressure fuel pump drive cam 39b for driving a high-pressure fuel pump is formed on an approximately center portion of the exhaust cam shaft 39 in a longitudinal direction of the exhaust cam shaft 39.

As shown in FIG. 6, the intake cam shaft 38 and the exhaust cam shaft 39 are respectively placed on the intake cam shaft bearing portions 26d and the exhaust cam shaft bearing portions 26e of the cylinder head 26. The intake cam shaft 38 and the exhaust cam shaft 39 are covered by the cam shaft holders 56 from above, and the bolts 57 are fastened to the bolt holes 26f so that the cam shaft holders 56 are fixed to the cylinder head 26. In a vehicle longitudinal direction, the intake cam shaft 38 is positioned and disposed on a rear side and the exhaust cam shaft 39 is disposed on a front side, and the intake cam shaft 38 and the exhaust cam shaft 39 are rotatably supported on the cylinder head 26 by the cam shaft holders 56.

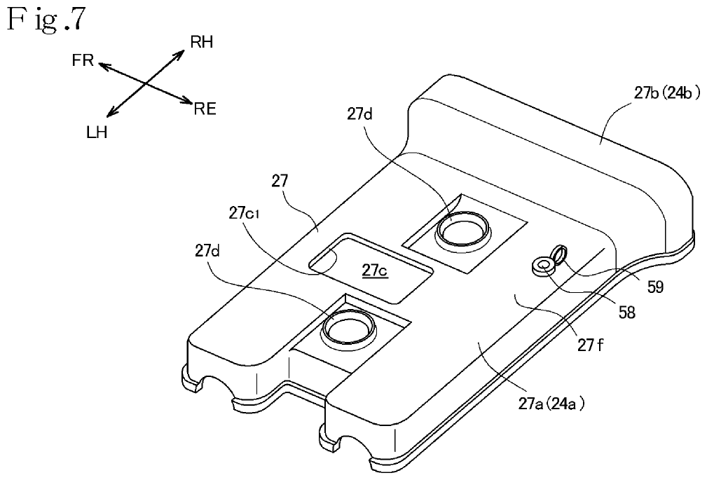

As shown in FIG. 7, the cylinder head cover 27 mounted on the upper surface of the cylinder head 26 includes a valve train housing portion 27a under which the valve train 15 is housed, and a cam chain chamber portion 27b bulges in a vehicle longitudinal direction and in an upward direction compared to the valve train housing portion 27a. The cam chain chamber portion 27b is disposed adjacently to a right side of the valve train housing portion 27a.

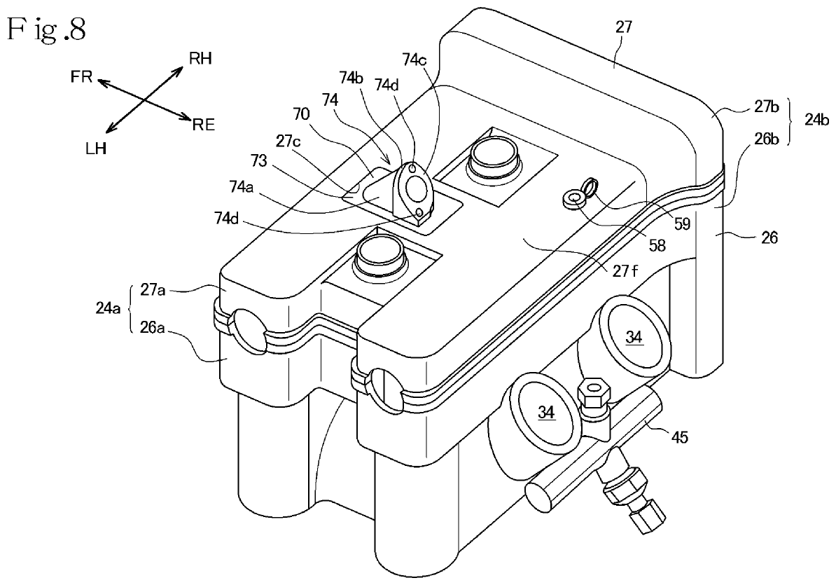

As shown in FIG. 8, when the cylinder head cover 27 is mounted on the cylinder head 26, the valve train housing portion 26a of the cylinder head 26 and the valve train housing portion 27a of the cylinder head cover 27 are combined with each other, thus forming a valve train housing portion 24a, and the cam chain chamber portion 26b of the cylinder head 26 and the cam chain chamber portion 27b of the cylinder head cover 27 are combined with each other, thus forming a cam chain chamber 24b.

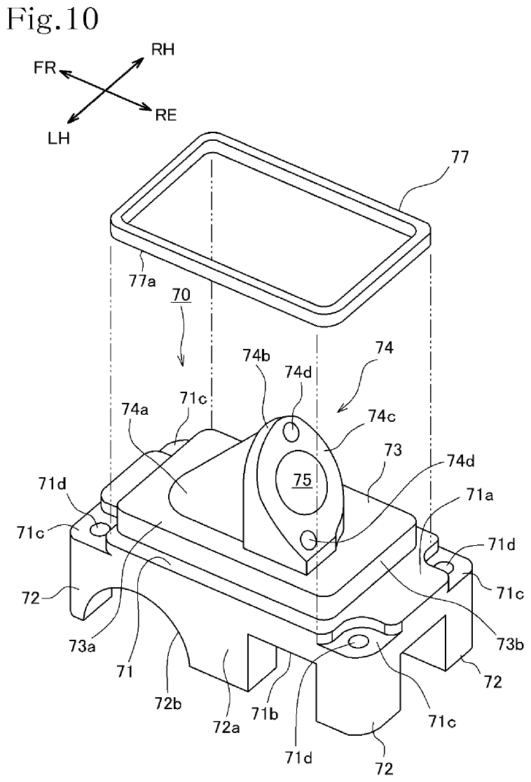

As shown in FIG. 7, an opening 27c which allows insertion of the fuel pump mounting member 70 therethrough is formed in the cylinder head cover 27 at an approximately center of the valve train housing portion 27a of the cylinder head cover 27. The opening 27c is formed by cutting away a portion of the cylinder head cover 27 in an approximately rectangular shape. The opening 27c has a size which allows fitting of a base portion 71 (see FIG. 10) of the fuel pump mounting member 70 therein. Sleeve portion insertion portions 27d allows insertion of the fuel injection valve insertion sleeve portions 26c (see FIG. 5) of the cylinder head 26 therethrough, respectively. The sleeve portion insertion portions 27d are formed on both left and right sides of the opening portion 27c.

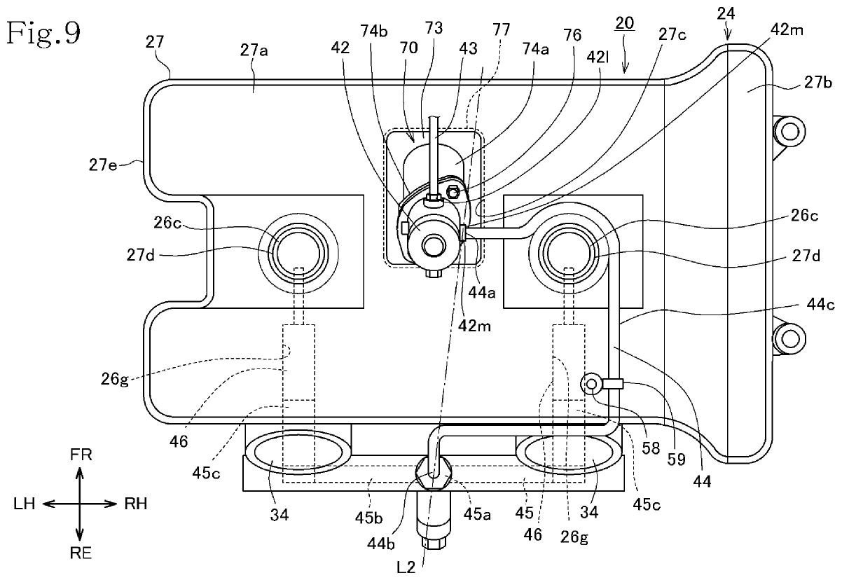

As illustrated in GIG. 8, a clamp seat 58 is mounted on a portion of an upper surface 27f of the valve train housing portion 27a of the cylinder head cover 27 on a right rear side of the upper surface 27f. A resin-made clamp 59 is detachably attached to the clamp seat 58, for example. As shown in FIG. 9, a high-pressure pipe 44, which is routed from a high-pressure fuel pump 42 (see FIG. 4) to be described later to a fuel injection valve 46 (see FIG. 4), is fixed to the upper surface 27f of the cylinder head cover 27 by the clamp 59.

As shown in FIG. 4, an intake valve 36 for opening and closing the intake port 34 which communicates with the combustion chamber 33, and an exhaust valve 37 for opening and closing the exhaust port 35 which communicates with the combustion chamber 33 are disposed in the cylinder portion 24.

The intake valve 36 and the exhaust valve 37 are brought into pressure contact with the intake cam 38a and the exhaust cam 39a respectively using springs not shown in the drawings by way of rocker arms 49. When power from the crankshaft 30 is transmitted to the intake cam shaft 38 and the exhaust cam shaft 39 using a cam chain not shown in the drawings, which is extended between and wound around cam gears 38c and 39c, the intake cam shaft 38 and the exhaust cam shaft 39 are rotated so that the intake valve 36 and the exhaust valve 37 are opened and closed at predetermined timings along with the rotation of the crankshaft 30.

As shown in FIG. 2, an intake device 50 is connected to the intake ports 34 in a state that the intake device 50 is positioned behind the internal combustion engine 20. The intake device 50 includes an air cleaner 51, a connecting tube 52, a throttle device 53, and an intake pipe 54. The air cleaner 51 takes in air to be fed into the internal combustion engine 20 and removes impurities and is mounted on the main frame members 2b. The throttle device 53 for regulating volume of intake air, the intake pipe 54, and the intake port 34 of the cylinder head 26 are sequentially connected to a downstream side of the air cleaner 51 by way of the connecting tube 52. Outside air taken in the air cleaner 51 is fed to the combustion chambers 33 through the intake ports 34 formed in the cylinder heads 26.

An exhaust device 60 is connected to the exhaust ports 35. The exhaust device includes an exhaust pipe 61, a catalyst device (not shown in the drawings), and a muffler 62. The exhaust pipe 61 which extends frontward is connected to the exhaust ports 35. The exhaust pipe 61 extends frontward and, thereafter, is bent downward, and extends rearward below the vehicle body. Below the vehicle body, the catalyst device is mounted on a middle portion of the exhaust pipe 61. The muffler 62 is connected to a rear end of the exhaust pipe 61, and exhaust air generated in the internal combustion engine 20 is discharged to the outside from an end portion of the muffler 62.

As shown in FIG. 2, in the crankcase 21 of the internal combustion engine 20, a crank chamber 22 is defined on a front side, and a transmission chamber 23 for housing a transmission (not shown in the drawings) is defined on a rear side. As shown in FIG. 1, power of the internal combustion engine 20 is transmitted to the rear wheel 7 by way of the transmission and a rear wheel drive chain 10.

As shown in FIG. 1 and FIG. 4, the internal combustion engine 20 adopts a direct-injection-type fuel supply device 40 where fuel is supplied directly to the combustion chambers 33.

As shown in FIG. 4, the fuel supply device 40 includes: the low-pressure fuel pump 41; the high-pressure fuel pump 42; the fuel injection valves 46 each of which forms a fuel injection device; a low-pressure pipe 43 which connects the low-pressure fuel pump 41 and the high-pressure fuel pump 42 to each other; the high-pressure pipe 44 which allows the high-pressure fuel pump 42 to be connected to a fuel injection valve 46 of the high-pressure pipe 44; and fuel supply passage portions 45 which connect the high-pressure pipe 44 and the fuel injection valves 46 to each other. The low-pressure pipe 43 forms an upstream-side fuel pipe with respect to the high-pressure fuel pump 42, and the high-pressure pipe 44 forms a downstream-side fuel pipe with respect to the high-pressure fuel pump 42.

As shown in FIG. 4, the low-pressure fuel pump 41 includes a body portion 41a for feeding fuel. A disc-like mounting seat 41b is formed on a lower portion of the body portion 41a for mounting the low-pressure fuel pump 41 on the fuel tank 11. A fuel flow-out portion 41c which is connected to the low-pressure pipe 43 is disposed below the mounting seat 41b. The low-pressure fuel pump 41 has a configuration where the mounting seat 41b is fixed to a lower surface 11a of the fuel tank 11 such that the body portion 41a is inserted into the fuel tank 11 and the fuel flow-out portion 41c protrudes downward from the fuel tank 11.

The low-pressure fuel pump 41 feeds fuel in the fuel tank 11 to the high-pressure fuel pump 42 by way of the low-pressure pipe 43. The connection of the low-pressure pipe 43 with the low-pressure fuel pump 41 and the connection of the low-pressure pipe 43 with the high-pressure fuel pump 42 are respectively made by a rotatable joint, and hence, at the time of performing the removal of the fuel tank 11 and so on, the joint is rotated so that excessive bending of the low-pressure pipe can be prevented.

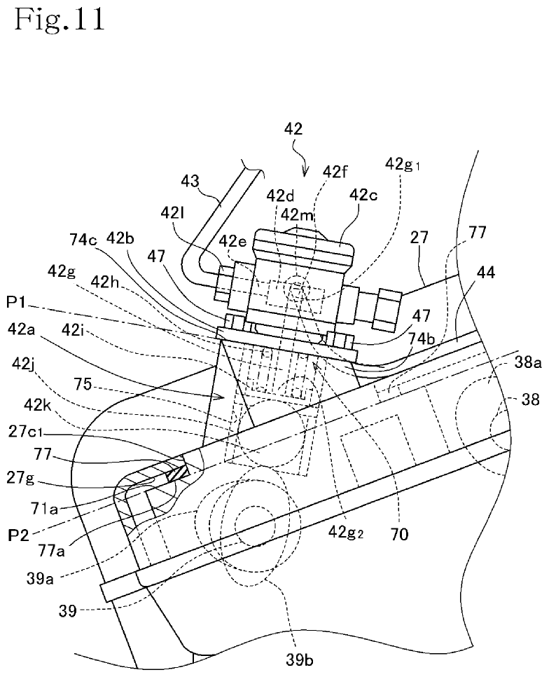

As shown in FIG. 11, the high-pressure fuel pump 42 is mounted on the cylinder head 26 by way of the fuel pump mounting member 70.

As shown in FIGS. 5, 6 and 11, the fuel pump mounting member 70, on which the high-pressure fuel pump 42 is mounted, is mounted on the fuel pump mounting member fixing portions 26g formed on an upper surface of the cylinder head 26 so as to cover a portion of the exhaust cam shaft 39.

As shown in FIG. 10, the fuel pump mounting member 70 has the flat-plate-like base portion 71 formed in an approximately rectangular shape. Leg portions 72 are formed on four corners of a lower surface 71b of the base portion 71. The leg portions 72 extend downward and are placed on and fixed to the fuel pump mounting member fixing portions 26g of the cylinder head 26. The pair of respective leg portions 72 on a front side has wall portions 72a extending rearward. The wall portions 72a are cut away in a semicircular shape corresponding to an approximately half of the cross-sectional shape of the exhaust cam shaft 39 thus forming a cam shaft holder portion 72b for supporting the exhaust cam shaft 39. Recessed portions 71c which are recessed downward are formed on four corners of an upper surface 71a of the base portion 71, respectively, and a bolt insertion hole 71d which penetrates also each leg portion 72 is formed in each recessed portion 71c.

As shown in FIG. 10, a flat-plate-like fitting portion 73 having an approximately rectangular shape is formed on the upper surface 71a of the base portion 71 in a raised manner. The fitting portion 73 is smaller than the upper surface 71a of the base portion 71. A ring-shaped seal member 77 is mounted on the fitting portion 73 so as to surround a periphery 73b of the fitting portion 73 in a state where the seal member 77 is brought into contact with the upper surface 71a of the base portion 71. The seal member 77 is set to have a height lower than a height of the periphery 73b. When the cylinder head cover 27 is mounted on the cylinder head 26, the fitting portion 73 is fitted in the opening 27c formed in the cylinder head cover 27 described later (see FIG. 8 and FIG. 9).

A fuel pump mounting portion 74 on which the high-pressure fuel pump 42 is mounted is formed on the upper surface 73a of the fitting portion 73 in a manner protruding from the upper surface 73a of the fitting portion 73. The fuel pump mounting portion 74 is formed on the upper surface 73a of the flat-plate-like fitting portion 73 with a configuration described below. A cylindrical portion 74a is formed on the upper surface 73a of the flat-plate-like fitting portion 73 in a rearwardly inclined manner toward the side of the intake cam shaft 38 with respect to the upper surface 73a of the flat-plate-like fitting portion 73. A mounting seat portion 74b having a seat surface 74c, on which the high-pressure fuel pump 42 is mounted, is formed on an end portion of the cylindrical portion 74a. A fuel pump insertion hole 75 is formed in the fuel pump mounting member 70 such that the fuel pump insertion hole 75 penetrates the fuel pump mounting member 70 from the fuel pump mounting portion 74 toward the base portion 71. The high-pressure fuel pump 42 is inserted into the fuel pump insertion hole 75. Bolt holes 74d are formed in the mounting seat portion 74b at positions above and below the fuel pump insertion hole 75. Bolts 76 for fastening the high-pressure fuel pump 42 are threadedly inserted into the bolt holes 74d, respectively.

As shown in FIG. 11, the fuel pump mounting member 70 is formed such that a fuel pump mounting plane P1 and a seal member mounting plane P2 are not arranged on the same plane, and are arranged so as to make a predetermined angle between these mounting planes P1 and P2. The fuel pump mounting plane P1 is a plane including the seat surface 74c on which the high-pressure fuel pump 42 is mounted, while the seal member mounting plane P2 is a plane including the upper surface 71a of the base portion 71 (see FIG. 10) with which a lower surface 77a of the seal member 77 mounted on the fitting portion 73 is brought into contact.

In the fuel pump mounting member 70, the angle of the fuel pump mounting plane P1 including the seat surface 74c of the mounting seat portion 74b is made different from the angle of the seal member mounting plane P2 on which the seal member 77 is mounted, so that the direction of a mating surface between the cylinder head 26 and the cylinder head cover 27 and the direction of vibrations of the high-pressure fuel pump 42 during its operation are made different from each other. For this reason, propagation of vibrations of the high-pressure fuel pump 42 is decreased so that noise is reduced.

As shown in FIG. 6, the fuel pump mounting member 70 is mounted in the vicinity of an approximately center of the cylinder head 26 in a vehicle width direction so as to straddle the exhaust cam shaft 39 transversely thereof. The bolts 76 which are made to pass through the bolt insertion holes 71d are fastened to the bolt holes 26h (FIG. 5) formed in the fuel pump mounting member fixing portions 26g of the cylinder head 26 so that the fuel pump mounting member 70 is fixedly secured to the cylinder head 26.

The high-pressure fuel pump 42 is a volumetric pump which is driven by the force of the crankshaft 30. As shown in FI. 11, the high-pressure fuel pump 42 is fixed with bolts 47 to the fuel pump mounting member 70, which is fixed to the upper surface of the cylinder head 26 in a protruding manner to penetrate the cylinder head cover 27. As shown in FIG. 3, the high-pressure fuel pump 42 is disposed between the pair of left and right main frame members 2b extending from the head pipe 2a, as viewed in a front view.

As shown in FIG. 11, the high-pressure fuel pump 42 includes a body portion 42a which is inserted into the fuel pump insertion hole 75 in the fuel pump mounting member 70. A flange-shaped mounting seat 42b is formed on an upper surface of the body portion 42a. A fuel flow passage portion 42c is provided above the mounting seat 42b.

The body portion 42a of the high-pressure fuel pump 42 includes a plunger 42g, a spring 42h, and a spring seat 42i which is integrally formed with one end portion 42g₂ of the plunger 42g. The spring 42h is interposed between the spring seat 42i and the mounting seat 42b, and the plunger 42g and the spring seat 42i are biased in a direction away from the mounting seat 42b.

A fuel flow passage 42d is formed in the fuel flow passage portion 42c of the high-pressure fuel pump 42. One end of the fuel flow passage 42d forms a suction port 42e through which fuel is sucked into the fuel flow passage 42d, and the other end of the fuel flow passage 42d forms a discharge port 42f through which fuel is discharged from the high-pressure pump. An intake side joint portion 42l is disposed on the side of the suction port 42e of the fuel flow passage portion 42c, the low-pressure pipe 43 is connected to the intake side joint portion 42l, and hence fuel is fed from the low-pressure fuel pump 41 and flows into the fuel flow passage 42d. As shown in FIG. 2 and FIG. 9, the intake side joint portion 42l is disposed on the side of the head pipe 2a of the motorcycle 1.

A discharge side joint portion 42m connected to the high-pressure pipe 44 is disposed on the side of the discharge port 42f of the fuel flow passage portion 42c, and the high-pressure pipe 44 is connected to the discharge-side joint portion 42m. Accordingly, fuel under pressure increased to a high value by the high-pressure fuel pump 42 is fed to the fuel injection valve 46 through the high-pressure pipe 44. As shown in FIG. 9, the discharge-side joint portion 42m is disposed on a right side surface of the fuel flow passage portion 42c.

An end portion 42g₁ (FIG. 11) of the plunger 42g on the side of a fuel flow passage 42d is configured to advance into or retract from the inside of the fuel flow passage 42d along with the rotation of the exhaust cam shaft 39, as will be described later. Check valves not shown in the drawings are disposed in the suction port 42e and the discharge port 42f of the fuel flow passage 42d, respectively, and these check valves are opened or closed at predetermined timings.

As shown in FIG. 9, the fuel pump mounting member 70 which protrudes from the cylinder head cover 27 is positioned at an approximately center of the cylinder head cover 27 in a vehicle width direction. The fuel pump mounting member 70 is directed rearward with respect to the upper surface 27f of the cylinder head cover 27, that is, the fuel pump mounting member 70 is disposed in a rearwardly inclined manner toward the side of the intake cam shaft 38. As shown in FIG. 11, the high-pressure fuel pump 42 is inserted into the fuel pump insertion hole 75 until the mounting seat 42b is brought into contact with the fuel pump mounting portion 74 of the fuel pump mounting member 70, and the high-pressure fuel pump 42 is fixed to the fuel pump mounting member 70 with the bolts 47. The high-pressure fuel pump 42 is mounted on the upper surface 27f of the cylinder head cover 27 of the cylinder portion 24 in an inclined manner such that the high-pressure fuel pump 42 is rearwardly inclined toward the side of the intake cam shaft 38.

The high-pressure fuel pump 42 is driven to feed fuel under pressure by the high-pressure fuel pump drive cam 39b which is formed on the exhaust cam shaft 39 in an integrally rotatable manner. A lifter 42k, which is supported by a cylindrical lifter guide 42j in a liftable manner, is brought into contact with a cam surface of the high-pressure fuel pump drive cam 39b. The plunger 42g which is biased by the spring 42h is brought into pressure contact with the lifter 42k on a side opposite to the high-pressure fuel pump drive cam 39b by way of the spring seat 42i. The lifter 42k is lifted or lowered along with the rotation of the exhaust cam shaft 39 so that the end portion 42g₂ of the plunger 42g advances into or is retracted from the fuel flow passage 42d.

As shown in FIG. 4 and FIG. 9, in the cylinder head 26 of each cylinder of the internal combustion engine 20, the fuel injection valve insertion sleeve portion 26c is formed. The fuel injection valve insertion sleeve portion 26c communicates with the combustion chamber 33 and is formed in a direction from a rear side toward a front side of the motorcycle. The fuel injection valve 46 which forms a fuel injection device for injecting fuel into the combustion chamber 33 is inserted into each of the fuel injection valve insertion sleeve portion 26c.

As shown in FIGS. 4, 6, and 9, the fuel supply passage portion 45 is formed on a back surface side of the cylinder head 26 such that the fuel supply passage portion 45 is directed in a vehicle width direction and is disposed parallel to the crankshaft 30. An inflow port 45a to which the downstream side connecting portion 44b of the high-pressure pipe 44 is connected is formed in the center of an upper surface of the fuel supply passage portion 45. Fuel supply passages 45b are formed in the fuel supply passage portion 45 in a branched manner toward right and left sides from the inflow port 45a. The fuel supply passages 45b are formed in a manner extending toward a front side of the internal combustion engine 20 so as to be connected to the fuel injection valves 46, and fuel is fed to the fuel injection valves 46 from outflow ports 45c.

In mounting the cylinder head cover 27 on the cylinder head 26, as shown in FIG. 10 and FIG. 11, the ring-shaped seal member 77 is mounted such that the ring-shaped seal member 77 is brought into contact with the upper surface 71a of the base portion 71 of the fuel pump mounting member 70 so as to surround the periphery 73b which surrounds the fitting portion 73. Then, the fuel pump mounting portion 74 of the fuel pump mounting member 70, which is fixed to the cylinder head 26, is inserted into the opening 27c formed in the cylinder head cover 27, and an inner periphery 27c₁ of the opening 27c of the cylinder head cover 27 is fitted on the periphery 73b of the fitting portion 73 of the fuel pump mounting member 70. As a result, the fuel pump mounting member 70 is mounted on the cylinder head cover 27 in a state where the seal member 77 is interposed between a lower surface 27g of the cylinder head cover 27 and the upper surface 71a of the base portion 71 of the fuel pump mounting member 70.

When the cylinder head cover 27 is mounted on the cylinder head 26, the fuel pump mounting portion 74 is positioned at an approximately center of the cylinder head cover 27 in a vehicle width direction, and the fuel pump mounting portion 74 protrudes rearward with respect to the upper surface 27f of the cylinder head cover 27, that is, in a rearwardly inclined state toward the side of the intake cam shaft 38.

As shown in FIG. 9, an upstream-side connecting portion 44a of the high-pressure pipe 44 is connected to a downstream side of the high-pressure fuel pump 42. A downstream-side connecting portion 44b of the high-pressure pipe 44 is connected to the inflow port 45a of the fuel supply passage portion 45. The high-pressure pipe 44 includes a detouring portion 44c routed in a lateral direction as viewed in plan view with respect to a line L2 which connects the upstream side connecting portion 44a and the downstream side connecting portion 44b to each other. The high-pressure pipe 44 is routed in a state where the high-pressure pipe 44 is disposed within a lateral width of the cylinder head cover 27.

The high-pressure pipe 44 is formed of a material having flexibility. For example, as the high-pressure pipe 44, it is possible to use a high-pressure fuel hose having resistance against a high-pressure and flexibility. Such a high-pressure fuel hose is formed of: an inner layer made of rubber or the like; a reinforcing layer formed by winding a yarn made of twisted metal threads, polyester threads or the like on an outer periphery of the inner layer; and an outer layer formed on an outer periphery of the reinforcing layer. In removing the cylinder head cover 27 from the cylinder head 26 for inspection or the like, it is unnecessary to remove the high-pressure pipe 44 from the high-pressure fuel pump 42. Accordingly, an inspection operation can be performed easily.

In a state where the high-pressure fuel pump 42 is mounted on the internal combustion engine 20, the high-pressure fuel pump 42 is disposed to be within the left, right, upper and lower outer edges 27e of the cylinder head cover 27 as viewed in direction of a cylinder axis L1.

As shown in FIG. 4, the low-pressure fuel pump 41 and the high-pressure fuel pump 42 are disposed such that the mounting seat 42b of the high-pressure fuel pump 42 and the mounting seat 41b of the low-pressure fuel pump 41 opposedly face each other, and the mounting seat 42b of the high-pressure fuel pump 42 is positioned in front of the mounting seat 41b of the low-pressure fuel pump 41.

The fuel supply device 40 is configured as described above, and supplies fuel into the combustion chambers 33 as follows. Pressure of fuel stored in the fuel tank 11 is increased by the low-pressure fuel pump 41 which is constantly operated during an operation of the internal combustion engine 20, and is fed to the high-pressure fuel pump 42 through the low-pressure pipe 43.

The plunger 42g of the high-pressure fuel pump 42 advances into the fuel flow passage 42d or retracts from the fuel flow passage 42d, following an upper surface of the high-pressure fuel pump drive cam 39b which rotates along with the rotation of the exhaust cam shaft 39, and, at the same time, the check valve is opened or closed at a predetermine timing. Accordingly, the high-pressure fuel pump 42 further increases pressure of low-pressure fuel supplied from the low-pressure fuel pump 41 and discharges the fuel to the high-pressure pipe 44. The high-pressure fuel pump 42 is driven by the exhaust cam shaft 39. Fuel whose pressure is increased by the high-pressure fuel pump 42 is fed under pressure to the fuel injection valves 46 through the high-pressure pipe 44 and the fuel supply passages 45b, and is injected into the combustion chambers by the fuel injection valves 46.

The motorcycle 1 with the mounted engine according to this embodiment is configured as described above and hence, the motorcycle 1 can acquire following advantageous effects.

The internal combustion engine 20 of this embodiment is mounted on the motorcycle 1, and includes: the cylinder head 26 in which the combustion chambers 33 are formed; the cylinder head cover 27 which covers the cylinder head 26; the fuel injection valves 46 whose injection ends are directed into the combustion chambers 33 respectively; the exhaust cam shaft 39 rotatably supported on the cylinder head 26; the high-pressure fuel pump 42 which feeds fuel due to an action of the high-pressure fuel pump drive cam 39b which integrally rotates with the exhaust cam shaft 39; the fuel pump mounting member 70 which is fixed to the cylinder head 26 in a state where the fuel pump mounting member 70 covers at least a portion of the exhaust cam shaft 39, and on which the high-pressure fuel pump 42 is mounted; and the high-pressure pipe 44 which supplies fuel from the high-pressure fuel pump 42 to the fuel injection valves 46 and has flexibility. With such a configuration, the high-pressure fuel pump 42 is mounted on the fuel pump mounting member 70 fixed to the cylinder head 26, and hence, the length of the high-pressure pipe 44 which feeds fuel from the high-pressure fuel pump 42 to the fuel injection valve 46 can be shortened, and thus a routing space of the high-pressure pipe 44 is made compact. Accordingly, the protection of a side of the vehicle including the high-pressure fuel pump 42 can be enhanced. Further, with the use of the high-pressure pipe 44 having flexibility, at the time of performing maintenance of the inside of the cylinder head 26, the maintenance of the inside of the cylinder head 26 can be performed while maintaining a connection state of the high-pressure pipe 44, and hence maintenance property around the cylinder head 26 can be enhanced.

The cylinder head cover 27 has the opening 27c, the fuel pump mounting member 70 has the mounting seat portion 74b on which the high-pressure fuel pump 42 is mounted, and the fuel pump mounting member 70 is disposed such that the fuel pump mounting member 70 penetrates the opening 27c of the cylinder head cover 27, and the mounting seat portion 74b protrudes from the cylinder head cover 27. Accordingly, the high-pressure fuel pump 42 can be removed from the fuel pump mounting member 70 while maintaining a joining state between the cylinder head cover 27 and the cylinder head 26, and hence maintenance property of the high-pressure fuel pump 42 can be further enhanced in cooperation with flexibility of the high-pressure pipe 44.

Further, the seal member 77 is interposed between the lower surface 27g of the cylinder head cover 27 and the upper surface 71a of the base portion 71 of the fuel pump mounting member 70 so as to surround the opening portion 27c of the cylinder head cover 27. Accordingly, sealing is ensured between the opening 27c of the cylinder head cover 27 and the fuel pump mounting member 70 without forming a gap, and it is hence possible to prevent leakage of oil at the time of removing and disassembling the high-pressure fuel pump 42.

Still further, the high-pressure pipe 44 has the slackened portion 44c routed in a lateral direction as viewed in plan view of the motorcycle 1 with respect to the line L2 which connects the upstream side connecting portion 44a connected to the high-pressure fuel pump 42 and the downstream side connecting portion 44b connected to the fuel injection valve 46 to each other. Accordingly, moving amount of the high-pressure pipe 44 is ensured due to the slackened portion 44c of the high-pressure pipe 44 and hence maintenance property of the inside of the cylinder head cover 27 can be enhanced.

The internal combustion engine 20 includes the low-pressure pipe 43 which feeds fuel from the fuel tank 11 to the high-pressure fuel pump 42 through the low-pressure fuel pump 41, the high-pressure fuel pump 42 has the intake side joint portion 42l to which the low-pressure pipe 43 is connected, and the intake side joint portion 42l is disposed on the side of the head pipe 2a of the motorcycle 1. Accordingly, the intake side joint portion 42l can be removed by making use of a wide space on the side of the head pipe 2a, and hence operability of removing the low-pressure pipe 43 at the intake side joint portion 42l can be enhanced.

Further, the high-pressure fuel pump 42 is disposed between the pair of left and right main frame members 2b extending from the head pipe 2a as viewed in front view. Accordingly, the high-pressure fuel pump 42 is not disposed on a side of the crankcase 21, but is disposed close to the center of the vehicle, and hence it is possible to prevent an impact to the high-pressure fuel pump 42 by a pebble or the like which impinges on the vehicle from the sides of the vehicle, thus enhancing the protection of the sides of the vehicle.

In the fuel pump mounting member 70, the fuel pump mounting plane P1 which includes the seat surface 74c of the mounting seat portion 74b and the seal member mounting plane P2 on which the seal member 77 is mounted have different angles, and hence the direction of the mating surface between the cylinder head 26 and the cylinder head cover 27 and the direction of vibrations of the high-pressure fuel pump 42 can be made different from each other. Accordingly, propagation of vibrations of the high-pressure fuel pump 42 can be decreased so that noise can be reduced.

Although one embodiment of the present invention has been described heretofore, the present invention is not limited to the above-mentioned embodiment, and it is needless to say that the various modifications are also conceivable without departing from the gist of the present invention.

For example, the internal combustion engine for a motorcycle according to the present invention is not limited to the internal combustion engine described in the embodiment, and the number of cylinders is set as desired provided that the internal combustion engine is an internal combustion engine for a motorcycle including claimed requirements. The motorcycle of the present invention is not limited to the motorcycle according to the embodiment.

### REFERENCE SIGNS LIST

1 . . . motorcycle

2 . . . body frame

2a . . . head pipe

2b . . . main frame member

11 . . . fuel tank

20 . . . internal combustion engine

26 . . . cylinder head

27 . . . cylinder head cover

27f . . . upper surface

27c . . . opening portion

33 . . . combustion chamber

38 . . . intake cam shaft

39 . . . exhaust cam shaft

39b . . . high-pressure fuel pump drive cam

41 . . . low-pressure fuel pump

42 . . . high-pressure fuel pump

42l . . . intake side joint portion

43 . . . low-pressure pipe

44 . . . high-pressure pipe

44a . . . upstream side connecting portion

44b . . . downstream side connecting portion

44c . . . detouring portion

46 . . . fuel injection valve

70 . . . fuel pump mounting member

74b . . . seat

74c . . . seat

77 . . . seal member

L1 . . . cylinder axis

P1 . . . fuel pump mounting plane

P2 . . . seal member mounting plane

1. An internal combustion engine for a saddle-riding vehicle, wherein the engine is mounted on the saddle-riding vehicle, the internal combustion engine comprising:
a cylinder head having a combustion chamber formed therein;
a cylinder head cover covering the cylinder head;
a fuel injection valve having a distal end directed to the combustion chamber;
a valve train cam shaft rotatably supported in the cylinder head and having thereon a cam integrally rotatable with the cam shaft;
a fuel pump mounting member fixed to the cylinder head in a state where the fuel pump mounting member covers at least a portion of the cam shaft;
a fuel pump for feeding fuel by an action of the cam, the fuel pump being fixedly mounted on the fuel pump mounting member; and
a downstream side fuel pipe for supplying fuel from the fuel pump to the fuel injection valve, the downstream side fuel pipe having a flexibility.

2. The internal combustion engine for a saddle-riding vehicle as claimed in claim 1, wherein:
the cylinder head cover has an opening;
the fuel pump mounting member has a mounting seat portion for mounting the fuel pump thereon; and
the fuel pump mounting member is disposed such that the fuel pump mounting member penetrates the opening of the cylinder head cover in such a manner that the mounting seat portion protrudes from an upper surface of the cylinder head cover.

3. The internal combustion engine for a saddle-riding vehicle as claimed in claim 2, wherein a seal member is interposed between the cylinder head cover and the fuel pump mounting member so as to extend along the opening.

4. The internal combustion engine for a saddle-riding vehicle as claimed in claim 3, wherein the downstream side fuel pipe has an upstream side connecting portion connected to the fuel pump and has a detouring portion routed in a vehicle lateral direction as viewed in plan view of the saddle-riding vehicle, with respect to a line which connects the upstream side connecting portion connected to the fuel pump and a downstream side connecting portion of the downstream side fuel pipe connected to the fuel injection valve.

5. The internal combustion engine for a saddle-riding vehicle as claimed in claim 3, wherein:
an upstream side fuel pipe is provided to feed fuel from a fuel tank to the fuel pump;
the fuel pump has an intake side joint portion to which the upstream side fuel pipe is connected; and
the intake side joint portion is disposed on a side of a head pipe of the saddle-riding vehicle.

6. The internal combustion engine for a saddle-riding vehicle as claimed in claim 5, wherein the fuel pump is disposed between a pair of left and right main frame members extending from the head pipe.

7. The internal combustion engine for a saddle-riding vehicle as claimed in claim 3, wherein:
the mounting seat portion of the fuel pump mounting member has a seat surface included in a fuel pump mounting plane (P1);
the fuel pump mounting member has a seal member mounting plane along which the seal member is mounted; and
the fuel pump mounting plane on the fuel pump mounting member and the seal member mounting plane of the fuel pump mounting member have different angles.

8. The internal combustion engine for a saddle-riding vehicle as claimed in claim 4, wherein:
an upstream side fuel pipe is provided to feed fuel from a fuel tank to the fuel pump;
the fuel pump has an intake side joint portion to which the upstream side fuel pipe is connected; and
the intake side joint portion is disposed on a side of a head pipe of the saddle-riding vehicle.

9. The internal combustion engine for a saddle-riding vehicle as claimed in claim 8, wherein the fuel pump is disposed between a pair of left and right main frame members extending from the head pipe.

10. The internal combustion engine for a saddle-riding vehicle as claimed in claim 4, wherein:
the mounting seat portion of the fuel pump mounting member has a seat surface included in a fuel pump mounting plane;
the fuel pump mounting member has a seal member mounting plane along which the seal member is mounted; and
the fuel pump mounting plane on the fuel pump mounting member and the seal member mounting plane of the fuel pump mounting member have different angles.

11. The internal combustion engine for a saddle-riding vehicle as claimed in claim 5, wherein:
the mounting seat portion of the fuel pump mounting member has a seat surface included in a fuel pump mounting plane;
the fuel pump mounting member has a seal member mounting plane along which the seal member is mounted; and
the fuel pump mounting plane on the fuel pump mounting member and the seal member mounting plane of the fuel pump mounting member have different angles.

12. The internal combustion engine for a saddle-riding vehicle as claimed in claim 6, wherein:
the mounting seat portion of the fuel pump mounting member has a seat surface included in a fuel pump mounting plane;
the fuel pump mounting member has a seal member mounting plane along which the seal member is mounted; and
the fuel pump mounting plane on the fuel pump mounting member and the seal member mounting plane of the fuel pump mounting member have different angles.

13. The internal combustion engine for a saddle-riding vehicle as claimed in claim 8, wherein:
the mounting seat portion of the fuel pump mounting member has a seat surface included in a fuel pump mounting plane;
the fuel pump mounting member has a seal member mounting plane along which the seal member is mounted; and
the fuel pump mounting plane on the fuel pump mounting member and the seal member mounting plane of the fuel pump mounting member have different angles.

14. The internal combustion engine for a saddle-riding vehicle as claimed in claim 9, wherein:
the mounting seat portion of the fuel pump mounting member has a seat surface included in a fuel pump mounting plane;
the fuel pump mounting member has a seal member mounting plane along which the seal member is mounted; and
the fuel pump mounting plane on the fuel pump mounting member and the seal member mounting plane of the fuel pump mounting member have different angles.
